(19) United States
(12) Patent Application Publication
(10) Pub. No.: US 2004/0162057 A1
(43) Pub. Date: Aug. 19, 2004

(54) Mobile telephone

(76) Inventor: Martin Steininger, Wien (AT)

Correspondence Address: BELL, BOYD & LLOYD, LLC, P. O. BOX 1135, CHICAGO, IL, 60690-1135, US

(21) Appl. No.: 10/482,849

(22) PCT Filed: Jul. 5, 2002
(86) PCT No.: PCT/DE02/02472

(30) Foreign Application Priority Data
Jul. 5, 2001 (DE) 101 32 585.1

(51) Int. Cl. H04M 1/68

(52) U.S. Cl. 455/411

(57) ABSTRACT

In addition to a conventional memory for storage of subscriber identification information, a second memory unit is provided in a mobile telephone for storage of user identification information and a third memory unit for storing personal user information.

The invention relates to a mobile telephone having a number of storage units.

The meteoric technical development in the field of mobile communication has led to the development and provision of a multiplicity of different applications for mobile telephones in recent years. Thus, it is known, to equip mobile telephones with an electronic telephone book, an electronic address book or an electronic appointments book. Such applications access personal data of the user of the mobile telephone which are stored in storage units of the mobile telephone.

It is also known to use the electronic telephone book of the mobile telephone in a different application for administering secret numbers in that, for example, instead of a name of a communication partner, the name of a credit card and instead of a telephone number associated with the name, the credit card number is stored. The disadvantageous factor in this is that everyone who is authorized for using the mobile telephone for communication purposes is, at the same time, also authorized for accessing these secret personal information items/data of a user.

The invention is then based on the object of specifying a mobile telephone which provides for a practicable and, at the same time, secure access to personal data of a user of the mobile telephone, stored, in the mobile telephone.

This object is achieved by the features of the independent claim. Advantageous and appropriate developments are found in the dependent claims.

Thus, according to the invention, a second storage unit for storing user identification information and a third storage unit for storing personal information of a user are provided in addition to a known storage unit for storing subscriber identification information, for example in addition to other storage units. As a result, a distinction is made between the access to services of the mobile radio system and the access to personal data of the user which are stored in the mobile telephone, when the mobile telephone is used. Distinguishing between subscriber identification and user identification makes it possible to allow a particular circle of persons to use services of a mobile radio system by means of the mobile telephone but, at the same time, to exclude this circle of persons from access to particular personal data of a user or of a group of users, and conversely. This makes it possible, for example, to lend a mobile telephone to someone or for a mobile telephone to be used jointly without complications.

The subscriber identification can be the subscriber identification of a mobile radio system which is known as such and in which a secret number input is compared with a number stored in a subscriber identification module (SIM) and in the case of a match, access to services of a corresponding mobile radio system is granted. As a rule, after the secret number has been successfully entered, the mobile telephone is automatically registered in the corresponding mobile radio system as a result of which the acceptance or the setting-up of a call via the mobile radio system is made possible.

The user identification can be the input of a secret number which is separate from the subscriber identification and which number can be different from said secret number. This also provides for access to personal data of a user without the attempted registration of the mobile telephone in a mobile radio system. This is also of advantage, for example, when a new address book entry is input in an aircraft because the attempted registration in a mobile radio system is prohibited in an aircraft.

The storage units can be mutually independent storage devices such as, for example, memory chips or different storage areas in a storage device.

In the text which follows, the invention will be described in greater detail by means of preferred exemplary embodiments with reference to the subsequent FIGURE:

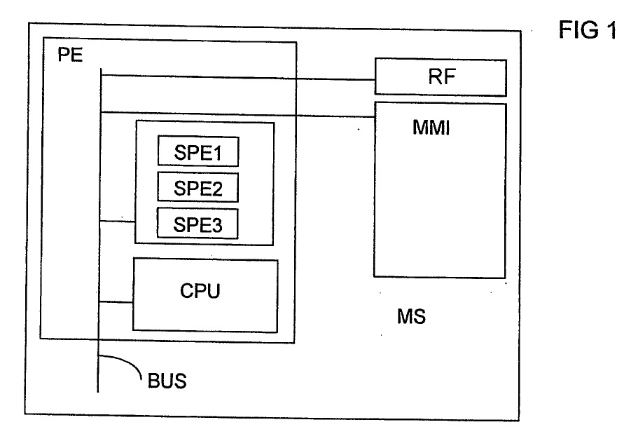

FIG. 1 block diagram of a mobile station.

FIG. 1 shows a mobile station MS (mobile telephone) which contains an operating device MMI, a radio-frequency device RF and a process device PE. The operating device MMI comprises a display unit and an input device, particularly for inputting identification information, which comprises, for example, keys or soft keys. The operating device MMI can also be constructed as a touch screen.

To control the mobile station MS, to drive the display unit and the methods which are executed by the mobile station, a program-controlled processor device PE such as, for example, a microcontroller is provided which can also comprise a processor CPU and a storage device which contains at least three storage units SPE1, 2, 3. In particular, the processor device is set up for comparing between identification information which has been input and identification information which has been stored, and for enabling or blocking storage units in dependence on the result of the comparison.

Depending on the variant of the embodiment, further components associated with the processor device, belonging to the processor device, controlled by the processor device or controlling the processor device such as, for example, a digital signal processor or other storage devices, the basic operation of which in connection with a processor device for controlling a mobile station is adequately known to an expert and which will not, therefore, be discussed in greater detail at this point, can be arranged inside or outside the processor device PE. The different components can exchange data with the processor CPU via a bus system BUS or input/output interfaces and possibly suitable controllers.

Depending on the variant of the embodiment, the storage device, which can be one or more volatile and/or non-volatile memory chips, or parts of the storage device, can be implemented as part of the processor device PE (shown in the FIGURE) or implemented as external storage device (not shown in the FIGURE) which is located outside the processor device PE and is connected to the processor device PE by means of suitable interfaces or a suitable bus system. The storage device can also be distributed storage elements which can be implemented at various locations in the mobile station. In particular, the storage device or a part of the storage device can be an exchangeable chip card such as, for example, a subscriber identification module.

In the storage device, the program data such as, for example, the control instructions or control procedures which are used for controlling the mobile station and for tracing the mobile station into various operating states are stored. In addition, user identification information, personal information of a user and subscriber identification information are stored in the storage device, particularly in its individual storage units SPE1, 2, 3, which can be blocked or enabled, respectively. The personal information of a user comprises at least one of the following electronically stored information items: telephone book, address book, credit card number, password and/or a secret number.

In the text which follows, variants of the embodiment for accessing personal information of a user which are comprised individually or also in arbitrary combinations in the invention are described by way of example:

Initially, the mobile telephone is in the switched-off state. When an ON key is pressed, the mobile telephone is switched on and the user is asked by means of a corresponding question displayed on the display unit whether he wishes to use mobile radio services or wishes to read out personal information.

If the user decides to use a mobile radio service by means of a corresponding input via the input unit, he is requested to input the subscriber identification information in a next step. After the user has input corresponding identification information, and this is compared with subscriber identification information stored in the first storage unit SPE1 and, in the case of a match, the access to mobile radio services is granted. This is associated with the registration in the mobile radio network and corresponding mobile-radio-system-specific identification procedures which are sufficiently well known as such and which, therefore, will not be discussed in greater detail at this point. However, the access to personal data of a user remains blocked, at least initially, even after the subscriber identification has been successful. It is provided in a variant of the embodiment of the invention that the input of user identification information and the associated user identification and the access to personal information of a user thus granted can also be performed after a successful subscriber identification.

If, in contrast, the user decides to read out personal information and to have it displayed on the output unit by means of a corresponding input, he is requested to input the user identification information in a next step. After corresponding identification information has been input by the user, it is compared with the user identification information stored in the second storage unit SPE2 and, in the case of a match, the access to personal information of the user or a corresponding group of users is granted. For this purpose, the personal information can be stored in the second storage unit SPE2 in accordance with the entries of an electronic telephone book, read out of this storage unit and displayed on the output unit. Thus, for example after the menu-controlled selection/input of the designation “credit card”, the credit card number is displayed or after selection/input of the designation “password PC”, the password for a PC of the user is displayed. The input or modification of such entries corresponds to the input or modification of entries of an electronic telephone book, known per se. However, the access to mobile radio services remains blocked, at least initially, even after successful user identification. A further variant of the embodiment of the invention provides that the input of subscriber identification information and the associated subscriber identification and the access to mobile radio services thus granted can also be performed after successful user identification.

A variant of the embodiment of the invention provides that the subscriber identification information is stored in a storage unit which is contained in an exchangeable chip card, particularly a subscriber identification module, whereas the user identification information and the personal information of a user are stored in fixed storage units of the mobile telephone.

Another variant of the embodiment of the invention provides for the subscriber identification information, the user identification information and the personal information of a user to be stored in storage units which are contained in an exchangeable chip card, particularly a subscriber identification module.

Finally, another variant of the embodiment of the invention provides for the subscriber identification information and the user identification information to be stored in storage units which are contained in an exchangeable chip card, particularly a subscriber identification module whereas the personal information of a user is stored in a fixed storage unit of the mobile telephone.

1. A mobile telephone (MS)
with a first storage unit (SPE1) for storing subscriber identification information,
with a second storage unit (SPE2) for storing user identification information,
with a third storage unit (SPE3) for storing personal information of a user,
with a device for inputting identification information (MMI),
with a processor device (PE) which is set up in such a manner that
the mobile telephone (MS) is authorized for registering in a mobile radio network when identification information input matches stored subscriber identification information, and
the access to the third storage unit is enabled when identification information input matches stored user identification information.

2. The mobile telephone as claimed in claim 1,
in which the subscriber identification information is identical with the user identification information.

3. The mobile telephone as claimed in one of the preceding claims,
with an exchangeable chip card which comprises at least one of the three storage units.

4. The mobile telephone as claimed in one of the preceding claims,
in which the input of the user identification information is only possible after the successful input of the subscriber identification information.

5. The mobile telephone as claimed in one of the preceding claims,
in which the input of the user identification information is possible before a successful input of the subscriber identification information.

6. The mobile telephone as claimed in one of the preceding claims,
in which the personal information of a user comprises at least one of the following information items: telephone book, address book, credit card number, password and/or a secret number.
